(19) United States
(12) Patent Application Publication
(10) Pub. No.: US 2017/0148079 A1
(43) Pub. Date: May 25, 2017

(54) System and Method of Providing Customers with In-Store Product Information

(71) Applicant: Benjamin Ponder, Winter Haven, FL (US)

(72) Inventor: Benjamin Ponder, Winter Haven, FL (US)

(21) Appl. No.: 15/360,378

(22) Filed: Nov. 23, 2016

Related U.S. Application Data
(60) Provisional application No. 62/259,106, filed on Nov. 24, 2015.

(51) Int. Cl. G06Q 30/06

(52) U.S. Cl. CPC G06Q 30/0625; G06Q 30/0633

(57) ABSTRACT

A system and method is provided for delivering in-store product information to customers using a remote server, a network, and one or more end user handheld devices. The method entails providing a network storage device with a product information database stored thereon. The storage device is connected to a network and the database is maintained by an administrator with the latest pricing information, inventory levels, and product location data for in-store products. A loadable application layer on the user handheld devices is provided for end users to access the product information database over the network. Users can query the product information database using the application layer to, among other things: select and view available products available in the store, create shopping lists, view sales, and calculate price totals for products placed on the user's shopping lists. Consumers are therefore afforded real-time product information while shopping or prior to arriving.

### CROSS REFERENCE TO RELATED APPLICATION

This application claims the benefit of U.S. Provisional Application No. 62/259,106 filed on Nov. 24, 2015. The above identified patent application is herein incorporated by reference in its entirety to provide continuity of disclosure.

### BACKGROUND OF THE INVENTION

### Field of the Invention

The present invention relates to systems and methods for providing store customers with a means to view real-time inventory data for products, to locate products in the store, and to create shopping lists while in the store or before arriving. More specifically, the present invention provides a system and method for providing data to in-store shoppers over a network and preferably through a handheld device, in which the shopping experience is improved for customers while shopping for various products.

Customers of brick and mortar stores have the ability to immediately procure desired products without waiting the same to be shipped to them, as with online shopping. However, customers must physically locate the desired products at the store and hope the price and quantity is sufficient for their needs. Therefore, knowledge of product inventory, product location within the store, and pricing data would be helpful for these customers. Whether the customer is shopping for a singular item in a large store, or shopping for multiple items, data about the products would facilitate efficient shopping experience and inform the customer of necessary product information.

In particular, locating a particular item can take time if the customer does not know the location of the particular item. Further still, the customer may be disappointed if inventory is low when the customer arrives at the product location. This leads to unnecessary shopping delays and multiple trips to different stores. Therefore improving information to in-store customers is desired to eliminate inefficiencies, improve the shopping experience, and reduce frustration. The present invention provides a system and method in which customers can locate desired products, view inventory data, compare prices, and develop shopping lists while in the store and/or before entering the store.

The present invention provides a system and method for providing product information to customers of brick and mortar stores, whereby data about available products is available to customers in-store and before entering the store. The present invention comprises a method of providing real-time product data via an accessible product database on a network storage device. The database is accessible over a network to end users, whereby an application layer allows the user to query the data and obtain real-time product information, inventory levels, and pricing information for shopping purposes. The application layer, through a graphic user interface (GUI), allows the user view the product data and create shopping lists, view product location and product details, and calculate a total purchase price from the created shopping list. This is helpful to customers of grocery stores, supermarkets, department stores, retail stores, big box stores, and the like. The steps of the method and the elements of the system are detailed below.

### SUMMARY OF THE INVENTION

The following summary is intended solely for the benefit of the reader and is not intended to be limiting in any way. The present invention provides a new system and method that can be utilized for providing customers with in-store product information while shopping or prior to the customer arriving at the store.

It is therefore an object of the present invention to provide a new and improved in-store product information system and method that has all of the advantages of the prior art and none of the disadvantages.

It is another object of the present invention to provide an in-store product information method that comprises the steps of providing a network storage device with a product information database stored thereon. The network storage device is connected to a network and is accessible via one or more client handheld devices over the network.

Another object of the present invention is to provide an in-store product information method that further comprises the steps of an administrator maintaining the product information database on the network storage device with current product inventory for a given store, pricing and sales information, and product location data for products on sale and located at a given store location.

Another object of the present invention is to provide an in-store product information method that further comprises the steps of an administrator providing an application layer that is loadable onto a client handheld device, which allows customers to access the product information database through their handheld devices over the network while in the store or before arriving.

Another object of the present invention is to provide an in-store product information method wherein the application layer is adapted to allow users to query the product information database, select therefrom available products and create shopping lists, and furthermore calculate price totals for all products on the user's shopping lists.

Another object of the present invention is to provide an in-store product information method wherein the product location data of the product information database further comprises the aisle location each product listed in the product information database.

Another object of the present invention is to provide an in-store product information method wherein the product information database further comprises a search popularity for each product listed in the product information database.

Another object of the present invention is to provide an in-store product information method wherein the product information database further comprises an alternative products list for each product listed in the product information database.

Another object of the present invention is to provide an in-store product information method wherein the product information database further comprises nutritional information for food products listed in the product information database.

Another object of the present invention is to provide an in-store product information method that further comprises the step of providing an application layer in which the shopping list can be organized by product location data of each product on the shopping list.

Another object of the present invention is to provide an in-store product information method that further comprises the step of providing an application layer in which users can query products from the product information database by product name and product category.

Another object of the present invention is to provide an in-store product information method that further comprises the step of providing an application layer in which users can query products from the product information database based on available sales discounts for each product listed in the product information database.

Another object of the present invention is to provide an in-store product information system that comprises a remote server having a processor, a storage, and a memory. The remote server is connected to a network, wherein the storage has a product information database stored thereon.

Another object of the present invention is to provide an in-store product information system wherein the product information database is accessible over the network. The product information database includes current inventory, price information, sales information, and product location data for products located at a given store location.

Another object of the present invention is to provide an in-store product information system wherein the product information database is accessible over the network via one or more wireless handheld devices having an application layer thereon. Moreover, the application layer is adapted to allow users to query the product information database, select therefrom available products and create a shopping list, and furthermore calculate a sales price total for all products on the shopping list.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner n which it may be made and used may be better understood after a review of the following description, taken in connection with the accompanying drawings wherein like numeral annotations are provided throughout.

FIG. 1 shows the system of the present invention.

FIG. 2 provides one screen of the application layer on the client handheld device, wherein the user account information is accessible.

FIG. 3 provides another screen of the application layer, wherein the user can search for products within a given store.

FIG. 4 provides yet another screen of the application layer, wherein the user view detailed information about products within the given store.

FIG. 5 provides a view of the user-compiled shopping list.

FIG. 6 shows a flow chart of the operator of the application layer, whereby a user can access the product information database and view product information at a given store.

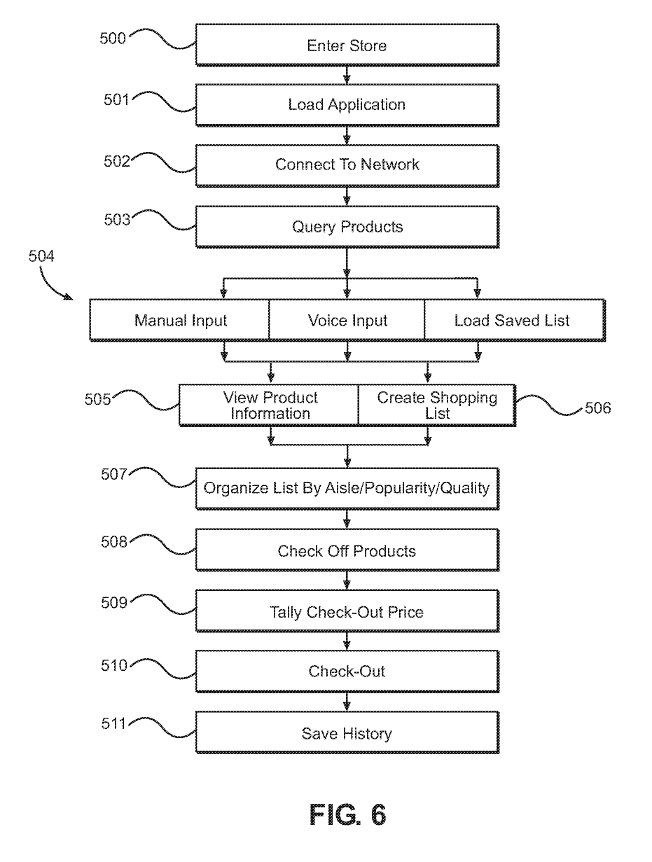

### DETAILED DESCRIPTION OF THE INVENTION

Reference is made herein to the attached drawings. Like reference numerals are used throughout the drawings to depict like or similar elements of the in-store product information method and system. For the purposes of presenting a brief and clear description of the present invention, the preferred embodiment will be discussed as used for providing customers with real-time data regarding the products available at the store, pricing data, and location of those items within the store. The figures are intended for representative purposes only and should not be considered to be limiting in any respect.

The present invention comprises a system and method that provides customers with in-store product information that can be accessed while the customer is in the store or prior to the customer arriving at the store. Customers value information and efficiency, particularly when shopping for a singular item in a large store, or shopping for multiple items scattered throughout the store. The present invention allows a customer to view available products in a given store, see inventory levels, check prices, create shopping list, and further locate items by their stock location in the store. This allows a customer to compare prices before entering, see all products available for purchase and alternatives, and quickly locate the desired products. The present invention includes a remote server and a loadable application on customers' handheld devices, which acts as a graphical user interface (GUI) from which the product data at the store can be interrogated and viewed.

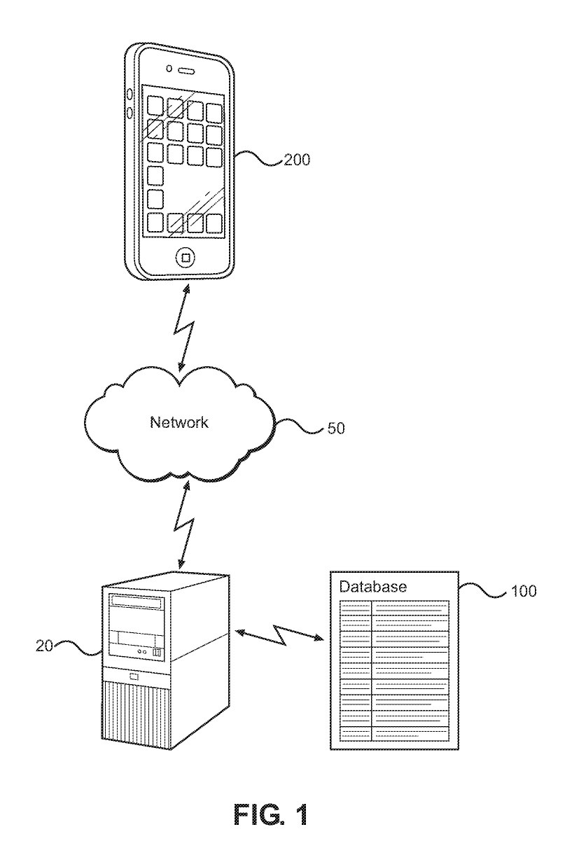

In particular and with reference to FIG. 1, the system of the present invention comprises a remote server 20 that is connected to a network 50. The remote server 20 comprises a computer processing unit (CPU), network server, or similar networked device that includes a processor, storage, and memory to facilitate storage of data and communication across the network 50 to one or more handheld electronic devices 200 operated by customers. The network 50 preferably comprises the internet, whereby the remote server 20 is connected thereto by an appropriate link such that data can be streamed from the server and to the handheld devices 200 of the customers.

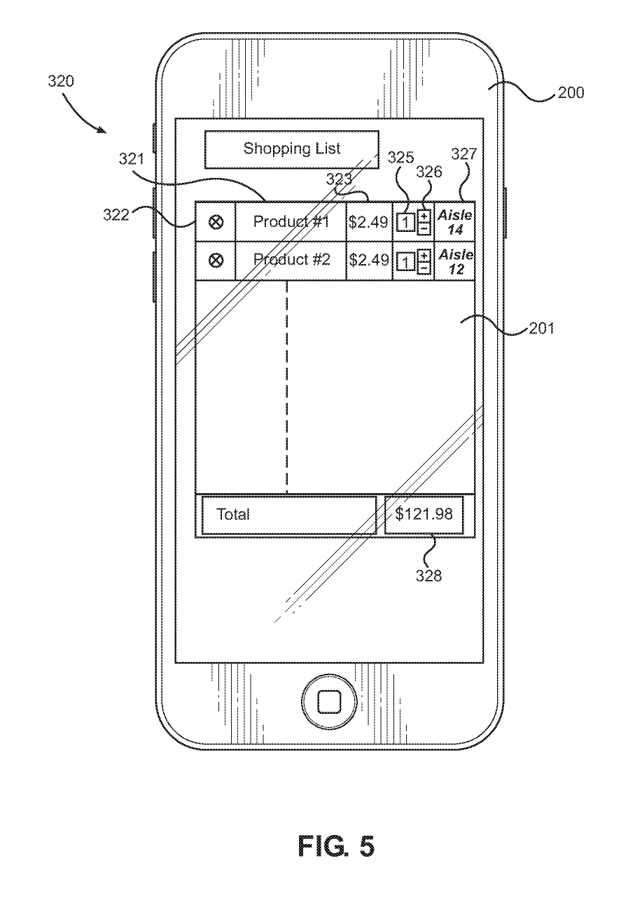

Stored on the remote server 20 is a product information database 100 that is owned, operated, and updated by an administrator. The administrator controls the data stored on the database, and is someone who maintains the currency and accuracy thereof relative to one or more stores. The data stored on the product information database 100 is accessible over the network 50 and is viewable on an application layer loaded on customers' handheld devices 200. A shown in FIGS. 1 through 5, the handheld devices 200 are electronic handheld devices, such as smartphones, tablets, or the like. The devices 200 have network connectivity, a processor, memory, storage, and a display sufficient for the user to interact with the application layer 205 and view the data from the product information database 100.

The product information database 100 is a database containing data for products sold at a given store location. The data is preferably updated regularly and current, such that customers accessing the data are given accurate information about products at the store. The database 100 may include several different types of data for each product, and may list all products at a given store. Moreover, the server 20 may include a plurality of databases that support data for multiple stores nationwide. The administrator of the database 100 controls the data thereon, whereby the data may be manually entered, or more preferably automatically generated based on incoming data from shipping receipts, store stocking information, and check-out receipts. An automated system is contemplated in which data for incoming products, outgoing products, and products on the shelves (or being taken off the shelves) is being driven into a protocol that filters the data and updates the database 100 accordingly to maintain its accuracy. The accuracy of the product data will be paramount to ensure customers rely on the system while shopping.

In particular, the product information database 100 preferably includes data reflecting in-store products and provides current inventory, pricing information, in-store product location, and general product facts for all or most products in the store. The database 100 is populated with relevant data that allows customers to query desired products, check availability, view alternatives, locate particular products, and determine the sales price of those products. The data is sent over the network 50 and transformed into a protocol that the application layer on the handheld device 200 can use to display to the user. Preferably, this data is streamed over a wireless network, such as a WiFi connection or cellular network, whereby the handheld device 200 is wireless and the data can be accessed while the user is in the store or otherwise away from home. Alternatively or concurrently, the application layer may be loadable onto a CPU at home, whereby the data may be accessed while at home while the user is determining where to shop and what products to purchase before leaving for the store. To this end, it is desired that the application layer allow the user to create shopping lists with products available in a given store and from data retrieved from the product information database 100.

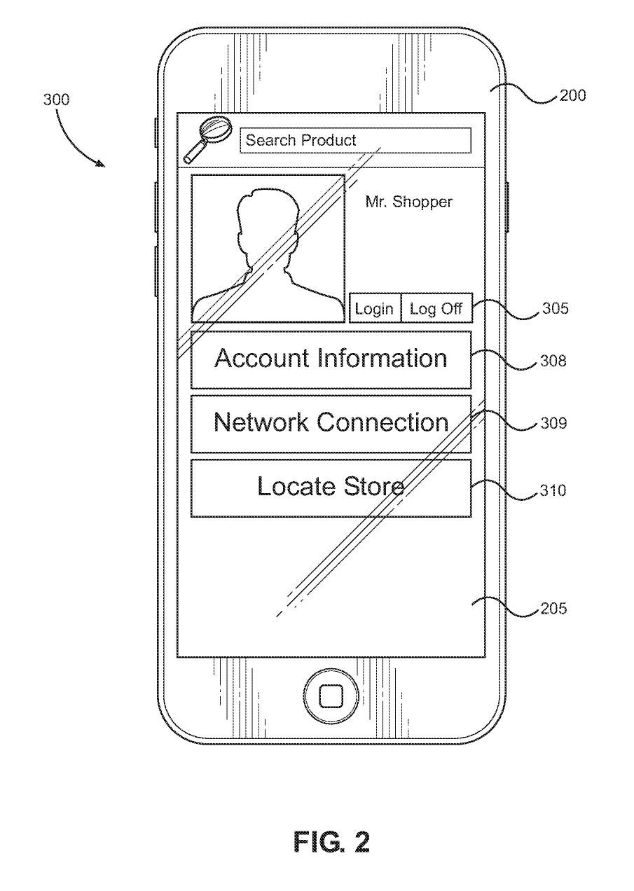

Referring now to FIGS. 2 through 5, there are shown exemplary screenshots of the application layer 205 of the present invention. The application layer 205 is a GUI that is stored and loaded on a user's handheld device and allows the user to retrieve and view data from the product information database 100 from the remote server. Each user preferably has an account and log in credentials in order to access the data on the remote server. Once credentialed and logged in, the user can view data from the database 100 and over the network. The users have read-only capability from the database 100, whereby the data is retrievable but the user has no privileges to change or manipulate any data on the database. As shown in FIG. 2, each user has an account with a user name and profile 308, which is verified before the user can retrieve data from the remote server. FIG. 2 shows an account details screen 300, whereby the user can review his or her account information 308, view local network connectivity 309, and choose a store location 310. One or more users may utilize the same handheld device 200, therefore log-on and log-off 305 capability may be provided.

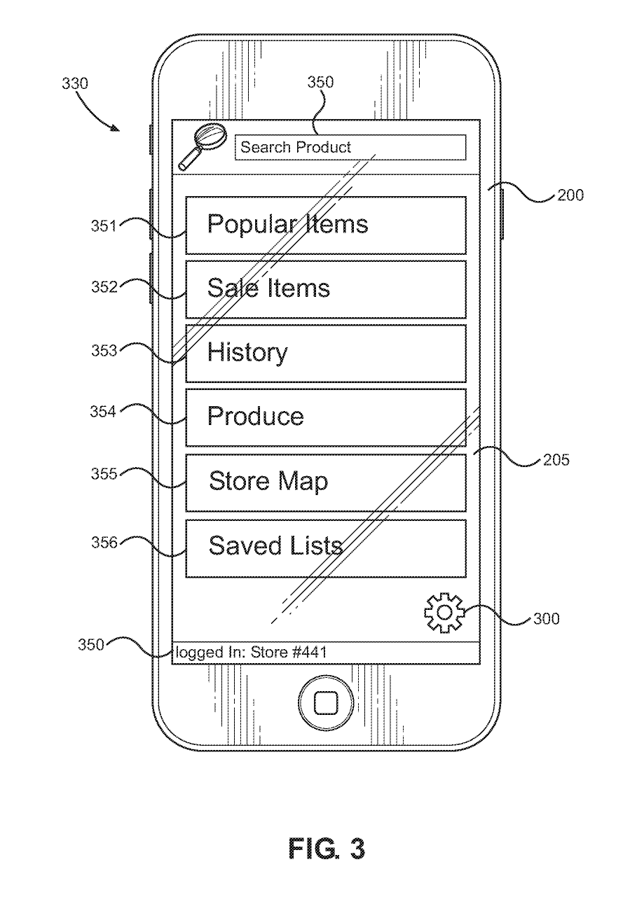

Referring now to FIG. 3, there is shown an exemplary screenshot of the application layer main screen 330. From this screen, the user can query desired products 350, view popular products 351, and sale items 352 for a particular store. The user preferably selects a given store location 350 and logs into the remote server with his or her credentials before accessing the product data. The store location 350 and account details 300 may be accessible from this main screen. Once logged in and a store is selected, the correct product information database is selected so data from a desired store can be interrogated. The user can then query for specific products or product categories from a text input bar 350, which will search the database for relevant products based on the user's input. In addition, popular items 351 that other consumers regularly shop for may be accessible from the main screen 330. Finally, sale items 352 and sales specials may also be accessible for the user to see reduced priced merchandise at the given store.

In addition, the main screen 330 may provide store specific categories, such as produce menus 354 for grocery stores, tire screens for auto repair stores, and the like. In these menus, data for specific products are available to the user. Moreover, it is desired to provide the user with a map of the store 355, particularly for larger stores. The map menu 355 provides store map with aisle information, whereby the user can view a floor map of the store and see how the aisles are numbered. The aisle numbers and floor map are useful when looking for particular products in a large store, or for organizing a large shopping list by location. Preferably, each product in the database includes location data, such as aisle and shelve data, which can be used in conjunction with the store map in order to locate the product. Finally, it is desired that the user be capable of creating shopping lists on the application layer. The main screen 330 provides access to the shopping list menu 356, in which the user can create new lists or view previously created lists.

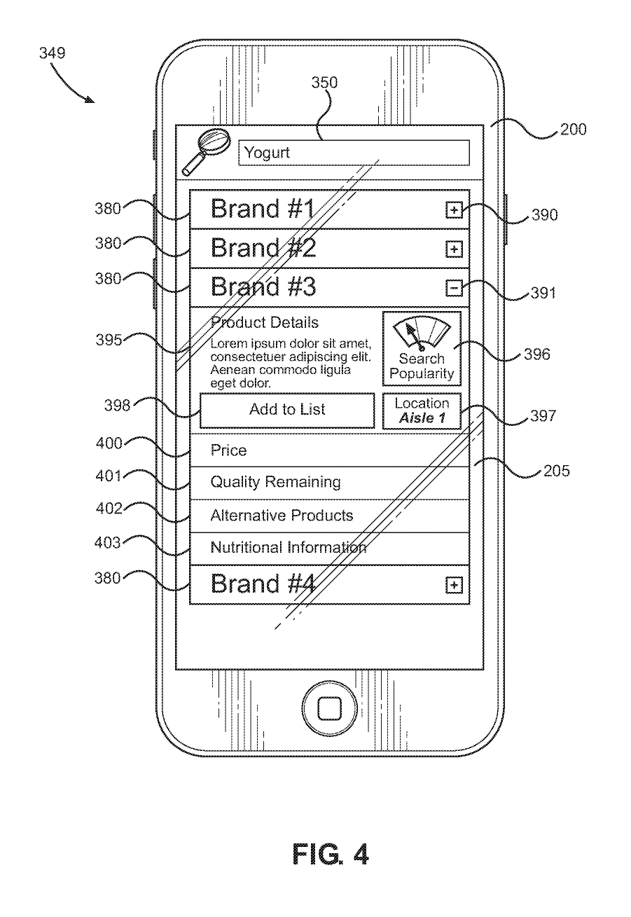

Referring now to FIG. 4, there is shown an exemplary embodiment of the product details screen 349. In this screen of the application layer 205, the query results from the user's input on the text input bar 350 are provided in list format. Alternatively, this screen may be used to browse products generally or view categories of products. As shown, this screen provides a list of several different products falling within a given category or resulting from a specific search. Several products 380 are listed, whereby the user can select a particular product to view its product details 395. From the product details list, information about the product may be provided, along with its search popularity 396, product location 397 in the given store, product pricing 400, its inventory or quantity remaining 401, as well as competing products 402 for the given product selected. For food products, nutritional information 403 may additionally be provided for the user to see the nutrition facts on the label of the food.

In addition to viewing product information, inventory, and location for products in the store, the application layer 205 also allows a user to create shopping lists. From the product details screen 349, selected products may be added to an ongoing shopping list 398, which can later be accessed and sorted as desired. Referring to FIG. 4, there is shown a shopping list screen 320, in which several products are listed in vertical fashion and can be organized as desired. It is contemplated that the user can create several different lists for different stores, or several lists for one store to be used at a later time or while the user is in the store. Each line item 322 in the list 321 may provide different variables upon which the overall list can be sorted. In particular, the list may include price information 323, popularity, quantity available, and/or location information 327. It may be desirable to locate and acquire products with limited remaining quantities first, and therefore sort the list according to quantity remaining and/or popularity. Moreover, it may be desired to organize the list based on the location 327 of each product, thereby allowing the user to acquire all products from each aisle without revisiting an aisle for an item still on the list.

Items can be added and removed from the list, and selected if acquired by the user. In addition, the pricing data 323 may be tallied into an overall checkout price 328 at the bottom of the list. This provides the user with a reference for the overall cost of the shopping trip. This is particularly useful when grocery shopping and budget shopping. The user can search for products and add them to the list, thereafter viewing the screen 201 of the handheld device 200 while shopping to view the list. Products acquired can be marked off, and the user can enter the checkout area with knowledge of the overall purchase price.

Overall, the present invention provides a system and a method that allows customers to view product data from a particular store and use it to facilitate efficient shopping, The present invention comprises a method having the steps of providing a storage device, such as a network server or the like, which contains a product information database stored thereon. The storage device is connected to a network and accessible thereover using a handheld device and/or a remote terminal, such as a personal computer. The method further entails an administrator maintaining the product information database with current inventory, price information, and product location data for products located at a given store location. The product database is accessible to consumers by providing an application layer for accessing the product information database through their handheld devices over the network. The application layer is one that is loaded onto the user's handheld device and is adapted to allow users to query the product information database, select therefrom available products and create a shopping list, and furthermore calculate a sales price total for all products on the shopping list.

The product information database may include several data points for each product, depending on how extensive the administrator wishes to make the product database. Example data for available products includes the above listed information, along with product popularity for each product, alternative products for each product, and nutritional information for food products. In addition, the products may be further cataloged into product categories, and indexed for efficient searching. Finally, the product database may include a unique listing of available sales discounts, or list sales prices as a data point for each available product. It is not desired to limit the type of data stored on the product information database; rather t is desired to provide exemplary data that a consumer would find helpful while searching and while creating shopping lists.

Referring to FIG, 6, there is shown an example flowchart in which the method and system of the present invention may be used by a customer. First, the user enters the store 500, whereupon he or she loads the application layer 501 on a handheld electronic device. The device is connected to a network 502, logs the customer onto the system using his or her credentials, and accesses the product information database. The user can then load previously saved shopping lists, or query products 503. The user can input text into the text input bar to query products using various inputs 504, or load a previously saved list. Thereafter, the user can view product information for specific products 505, create a new shopping list 506, or view saved list. While shopping, the user can then organize the list 507 according to his or her needs, check off products 508 acquired, and tally an overall sales price 509. Finally, the user can take the products to a check-out counter 510, whereafter the application can be closed and the search history and shopping list is saved 511 for future reference. The lists and history are preferably saved locally on the user's handheld device. Overall, the present invention facilitates efficient shopping and provides customers with more information while shopping. Utilizing this system and method can drive business to the store, as consumers can use the application on their devices to access information about products available in the store.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of providing in-store product information to customers, comprising the steps of:
providing a storage device with a product information database stored thereon, the storage device being connected to a network;
maintaining the product information database with current inventory, price information, and product location data for products located at a given store location;
providing an application layer for accessing the product information database through one or more client handheld devices over the network;
wherein the application layer is adapted to allow users to query the product information database, select therefrom available products and create a shopping list, and furthermore calculate a sales price total for all products on the shopping list.

2) The method of claim 1, wherein the product location data of the product information database further comprises the aisle location each product listed in the product information database.

3) The method of claim 1, wherein the product information database further comprises a search popularity for each product listed in the product information database.

4) The method of claim 1, wherein the product information database further comprises an alternative products list for each product listed in the product information database.

5) The method of claim 1, wherein the product information database further comprises nutritional information for food products listed in the product information database.

6) The method of claim 1, further comprising the steps of:
providing an application layer in which the shopping list can be organized by product location data of each product on the shopping list.

7) The method of claim 1, further comprising the steps of:
providing an application layer in which users can query products from the product information database by product name and product category.

8) The method of claim 1, further comprising the steps of:
providing an application layer in which users can query products from the product information database based on available sales discounts for each product listed in the product information database.

9) A system for providing in-store product information to customers, comprising:
a remote server comprising a processor, a storage, and a memory;
a network;
wherein the storage comprises a product information database stored thereon, and the product information database is accessible over the network;
wherein the product information database further comprises current inventory, price information, and product location data for products located at a given store location;
wherein the product information database is accessible over the network via one or more wireless handheld devices having an application layer thereon;
wherein the application layer is adapted to allow users to query the product information database, select therefrom available products and create a shopping list, and furthermore calculate a sales price total for all products on the shopping list.

10) The system of claim 9, wherein the product location data of the product information database further comprises the aisle location each product listed in the product information database.

11) The system of claim 9, wherein the product information database further comprises a search popularity for each product listed in the product information database.

12) The system of claim 9, wherein the product information database further comprises an alternative products list for each product listed in the product information database.

13) The system of claim 9, wherein the product information database further comprises nutritional information for food products listed in the product information database.
